(19) United States
(12) Patent Application Publication
(10) Pub. No.: US 2003/0124225 A1
(43) Pub. Date: Jul. 3, 2003

(54) Encapsulated alcoholic beverage

(76) Inventors: Paul West, (US); William Keith Middleton, (US)

Correspondence Address: VAN DYKE & ASSOCIATES, P.A., 7200 LAKE ELLENOR DRIVE, SUITE 252, ORLANDO, FL, 32809, US

(21) Appl. No.: 10/201,634

(22) Filed: Jul. 23, 2002

Related U.S. Application Data
(63) Continuation-in-part of application No. 09/430,906, filed on Nov. 1, 1999.

(51) Int. Cl. A23L 1/00

(52) U.S. Cl. 426/89

(57) ABSTRACT

Disclosed herein is an ingestible, chewable, or aqueous soluble non-toxic capsules containing sufficient quantities of ethanol compositions to facilitate transport of recreationally relevant quantities of such ethanol compositions for ingestion and appreciation of the physiological effects of such ingestion.

### CROSS-REFERENCE TO RELATED APPLICATIONS

This application is a continuation in part of U.S. patent application Ser. No. 09/430,906, pending, filed Nov. 1, 1999, and to which priority is claimed under 35 USC § 120.

### FIELD OF THE INVENTION

This invention pertains to the field of ingestible recreational beverages, and in particular, to recreational beverages with a significant alcohol content, contained within a non-toxic, ingestible, chewable or water soluble capsule.

### BACKGROUND OF THE INVENTION

Since the invention of the rotary die encapsulation machine by Robert Pauli Scherer in 1930, the production of soft gelatin capsules has been predominately used in the pharmaceutical and health food industry. Soft gelatin capsules are typically prepared from a combination of gelatin, glycerin and water, and can absorb several times their own weight in water. The glycerin makes the gelatin more flexible by disrupting cross-links between the protein chains. If the capsules get wet enough, they dissolve. Even out of the rain, they eventually absorb enough atmospheric water to become an excellent growth medium for bacteria and fungi. In the field of bacteriology, it has been known that these organisms will digest the gelatin using proteolytic enzymes (biological catalysts cut long protein chains into shorter pieces).

There is a well established base of knowledge relating to the manufacture of encapsulated liquid and powder formulations. For example, U.S. Pat. No. 3,653,934 provides a method for making a gastro-resistant gelatin capsule. U.S. Pat. No. 3,656,997 provides a method for making coated gelatin capsules. U.S. Pat. No. 3,959,540 provides gelatin capsules resistant to gastric juice dissolution. U.S. Pat. No. 3,779,942 provides capsules and processes for manufacture thereof which provide an improved vapor barrier. U.S. Pat. No. 6,280,767 provides a soft gelatin capsule comprising gelatin, plasticizer, glycerin, a sugar, glycol, and a water-insoluble cellulose. However, this patent does not teach encapsulating an alcoholic substance. For their teachings of capsule formation, these references are hereby included by reference. However, no disclosures have been found where such encapsulation methodologies or devices were implemented for provision of recreational encapsulated alcoholic beverages.

In the field of human medicine, there are instances of medicinal compositions formulated in an excipient, such as a small quantity of ethanol, encapsulated within a capsule made from gelatin or another non-toxic, digestible or non-digestible material. However, in such formulations, the total content of ethanol is intentionally maintained at an essentially nominal level, in order to avoid alcohol induced effects, such as inebriation or mood alteration. For example, in U.S. Pat. No. 4,888,239, there was provided an ethanol fill formulation for softgels and the like wherein a small quantity of ethanol (milligram quantities) was provided as a solvent for other ingredients, and the entire liquid composition was encapsulated in a gelatin capsule. It should be noted that in the referenced patent, the inventor appeared to have been under the misapprehension that in order for compositions containing greater than ten percent (10%) ethanol content to be successfully encapsulated in a gelatin capsule, such additional ingredients as partial glycerides must be included in the encapsulated composition.

U.S. Pat. No. 4,744,988 relates to a soft gelatin capsule and method for their production. The capsule comprises a shell of gelatin, sorbitol, and a softener and a filling consisting of polyethylene glycol (PEG), a low polyhydric alcohol, glycerol or propylene glycerol, and an active substance. The capsule shell does not contain HPMC and the filling does not contain alcohol of recreational amounts for an alcoholic beverage.

Polyethylene glycol has a high affinity to the material of a gelatin-based shell. In most cases, the hardness and flexibility of the capsule shells start to change shortly after the production of such capsules, due to reciprocal effects between the fillings, which contain

PEG's, and the soft gelatin capsules, which contain softeners. In many cases, the shells of the capsules get so brittle that the enclosure bursts and the fillings contained within them are released. Sometimes it even happens that such brittle capsules are destroyed already during transportation as bulk material because they cannot resist mechanical stresses encountered.

In other cases, the affinity of PEG's to shells may induce the PEG's to diffuse during storage from fillings into the gelatin enclosure. Since the PEG's act as softeners, the capsules get very soft. They stick together and deform, and when sealed into plastic films they can no longer be pressed out without damage to the capsules. In addition, the PEG's diffuse through the enclosure so that the surface of the shell gets smeary. Capsules in this condition must be discarded.

In U.S. Pat. No. 4,834,981, a “vaccine” was described for preventing metabolism of ingested methanol, through delivery of small quantities of encapsulated ethanol. The selective metabolism of ethanol which is gradually released from a carrier means was intended to limit the level of methanol metabolized after swallowing the vaccine. However, as with the other medicinal encapsulated compositions known in the art, the composition contemplated by this patent is expressly designed to avoid induction of any ethanol-induced intoxicating effects. Accordingly, the referenced patent teaches away from the present invention in which a sufficient quantity of ethanol is delivered in an encapsulated form to induce a recreational effect similar to ingesting a social alcoholic beverage.

In the field of human food consumption and confections, there have been instances of liqueur-filled chocolates and the like. However, as with the known medicinal capsules discussed above, the total alcohol content of such confections has historically been of such a low total amount that inebriation effects of the contained alcohol are essentially negligible.

It is known to generate a consumable item colloquially known as a “Jell-O-Shot”, which is essentially a gelatin-based desert composition, mixed with a shot (approximately 1-2 ounces) of an alcoholic beverage, and then allowed to cool and gel. Consumed in this form, alcohol can be ingested for recreational purposes as a novelty activity at an adult party and the like. However, in Jell-O-Shots, the alcohol is dispersed within the gelatin composition, essentially uniformly, and there is no encapsulating shell. As a result, such alcohol compositions are not easily transportable, have no mechanical strength, and are subject to “melting” or liquefaction if retained at ambient or slightly above ambient temperatures.

Alcohol is the ordinary name for a substance called ethyl alcohol (ethanol), grain alcohol, or pure spirits. Ethyl alcohol, or ethanol, is formed as wine or hard wine by the fermentation of any sweet fruit juice. Industrial ethyl alcohol may be made from molasses, potatoes, or grains, chiefly corn. The dilute alcohol obtained is then distilled to recover industrial alcohol of 96% strength (4% water). It requires an additional treatment to make alcohol of 100% strength. In the human body, ethanol in intoxicating or recreational amounts in beverages is rapidly absorbed in the stomach and upper intestine and quickly enters the circulatory system. An alcoholic drink is any beverage that contains ethyl alcohol in intoxicating quantities. The amount of alcohol may be as low as 2%, as in some beers, or it may be as high as 70%, as in absinthe. The alcoholic content of some beverages is measured in proof, which is roughly about twice the % of alcohol by volume. For example, a 90 proof whisky contains about 45% alcohol. The alcohol in these drinks is obtained by the fermentation of sugar or of starchy products such as corn, barley, wheat, rye, rice, and potatoes, when their starch is changed to sugar. Beverage alcohol may also be obtained by distilling fermented mashed fruit or grain.

Of course, alcoholic beverages are commercially available in small bottles or other containers made of glass, plastic or the like. However, such containers are not ingestible, chewable, or readily dissolvable when contacted with a liquid such as an aqueous beverage.

Accordingly, there remains a need for a readily transportable alcoholic composition for recreational ingestion of alcohol wherein a sufficient quantity of alcohol is held within an ingestible, chewable or aqueous soluble capsule to permit one or a plurality of such capsules to be ingested, chewed or dissolved to provide the recreational physiological effects for which alcohol is generally consumed as a recreational activity.

### SUMMARY OF THE INVENTION

This invention provides ingestible, chewable, or aqueous soluble non-toxic capsules containing sufficient quantities of ethanol to facilitate transport, storage, delivery and consumption of recreational quantities of such alcohol compositions.

One embodiment of the present invention is a gelatin-based capsule comprising gelatin, an alcohol sugar (preferably sorbitol), water, propylene glycol, glycerin, and Hydroxypropylmethylcellulose (HPMC). A most preferred embodiment of the capsule comprises about 45% gelatin, about 27% sorbitol special, about 17% water, about 10% propylene glycol, about 1% glycerin, and at least 2 g/kg of HPMC. After the gelatin bass composition is mixed, HPMC is added at a desired concentration to obtain optimum hardness and flexibility of the capsule.

The fill formulation of this embodiment preferably comprises at least 70% ethyl alcohol, about 20% water, about 9% sugar(s) (preferably D-fructose), and at least 1% of at least one excipient or flavoring component depending the use of the capsule. A most preferred embodiment of the fill formulation comprises about 70-80% ethyl alcohol, about 20% water, about 9% sugar(s), and about 1% of at least one excipient or flavoring component.

Accordingly, it is one object of this invention to provide an easily transportable recreational quantity of ethanol in an ingestible container, such as a capsule.

Another object of this invention is to provide an easily transportable recreational quantity of ethanol in a chewable container, such as a capsule.

Another object of this invention is to provide an easily transportable recreational quantity of ethanol in an aqueous soluble container, such as a capsule.

It is an object of the present invention to provide a soft gelatin capsule and formulation containing a sufficient amount of ethanol for recreational and commercial purposes.

It is another object of the present invention to provide a gelatin-based capsule and alcohol formulation, which comprises a method whereby the gelatin capsules do not stick to one another during and after the manufacture process.

It is a further object of the present invention to provide a soft gelatin capsule and formulation comprising an effective amount of ethanol to have a recreational effect on an average adult human.

It is still a further object of the present invention to provide a soft gelatin capsule that comprises a composition to prevent against mechanical stresses associated with packaging, transporting, and storing of such capsules.

It is still another further object of the present invention to provide soft gelatin capsules as a kit or provide a plurality of such ethanol filled capsules for commercial or recreational use.

Other objects and benefits of this invention will be apparent from a review of the complete disclosure and the claims appended hereto.

### DETAILED DESCRIPTION OF THE PREFERRED EMBODIMENTS

As used in this disclosure and the claims appended hereto, the terms “recreational quantities” and “recreationally relevant quantities” of an alcoholic composition refers to any amount of an ethanol containing composition which, alone or in combination with repeated doses of the same amount of ethanol, produces a noticeable recreational physiological effect on the consumer of such a quantity of ethanol. Thus, consumption of between about one and about ten capsules according to this invention are considered to come within the scope of this definition of recreationally relevant quantities of ethanol containing capsules. Preferably, on a per capsule basis, a recreationally relevant quantity of alcohol pertains to at least 2.5 ml of alcohol per capsule.

In a first embodiment of this invention, a small, soft, thick-walled, edible sphere, ellipse, elongated tube, or similarly shaped capsule composed of gelatin, alginate, xanthan gum, guar gum, chitin, chitosin, gellan gum, agar, carrageenan, albumin, starch, carboxymethylcellulose (CMC), mixtures thereof, similar polymers, or the like is provided containing within an enclosed cavity approximately 0.5 to 1.5 ounces of ethanol. Alginate is one preferred encapsulating material because it is highly water soluble, but is insoluble in ethanol and ethanol/water mixtures. It is also inexpensive, and is acceptable as a foodstuff. However, gelatin has the advantage as an encapsulating material in that it is heat-moldable. The ethanol contained within the cavity formed by the gelatin, alginate or like material may be pure, substantially pure, or relatively dilute ethanol, for addition to and dissolution in an aqueous solution, such as a fruit juice, soft drink (e.g. any commercially available mixer, soda, or the like), or in water. Alternatively, the alcohol may be mixed with water, syrup, gel, flavoring or the like, such that the capsule may be directly dissolved in a person's mouth, chewed or swallowed for dissolution inside the digestive tract, or dissolved in a consumable aqueous solution. The alcohol content may be between about 5% and about 95% ethanol, and preferably is in the range between about 25% to about 70%, and most preferably, in the range between about 40% and about 50% ethanol. The total internal volume of the capsule is preferably between about 2.5 milliliters to about 50 milliliters, and most preferably between about 5 milliliters and about 30 milliliters.

It will be appreciated that any encapsulating, non-toxic material may be used according to this invention to deliver the ethanol composition for recreational purposes. However, it is preferred for the encapsulating material to be digestible, in instances where the encapsulating material is designed to be ingested along with the contents. In such instances, the encapsulating material should be comprised of gelatin or alginate or like digestible material, and the capsule may be designed for breakage in the consumer's mouth. To that end, it may be, in addition, desirable for the capsule to be coated with a sugar coating or the like, such that as the capsule contacts the salivary juices in the mouth, additional saliva is produced, the capsule has a pleasant taste, and as the sugar dissolves, it ensures ease of swallowing the broken capsule. In a further embodiment, where it is intended for the capsule not to be swallowed, such as, for example, where the consumer bites the capsule to release its contents and spits the encapsulating material out it is preferred for the capsule to have a shape that would prevent swallowing, but which at the same time would ensure that choking on the capsule is extremely unlikely or impossible, such as, for example, where the capsule is substantially too large to swallow, in which case the capsule has to be broken in the mouth, for example by chewing, or dissolved in an aqueous beverage, which is then swallowed in liquid form. In another alternative embodiment, where the capsule is intended not for ingestion, the capsule may be in the form of a life-saver buoy, i.e. being of a contiguous tubular shape in the form of a circle, with an internal canal or cavity, such that upon the unlikely event of lodgment in a consumer's throat, there is sufficient space for air to pass through the canal to prevent asphyxiation.

It will be appreciated from this disclosure that it is preferred for the encapsulating material to be capable of sustaining various concentrations of ethanol within the internal compartment, without dissolution into the ethanol. It is also preferred for the encapsulating material to be of sufficient rigidity to sustain packaging and storage for from several minutes to several weeks or months. This goal is achievable using gelatin, if sufficient concentrations of gelatin are incorporated into the encapsulating material, or where the molecules constituting the gelatin capsule are cross-linked with a cross-linking agent, such as but not limited to glutaraldehyde. Methods of achieving this goal are known in the art and therefore, are not discussed in detail here. Alternative encapsulating materials which meet these criteria include waxes, synthetics and the like, which are non-toxic and stable in the presence of ethanol compositions. For such compositions, chewing and ejecting the capsule may be preferred.

In a further embodiment of this invention, the capsule comprises a pH sensitive component such that known dissolution characteristics may be imparted to the encapsulant. Thus, for example, encapsulating compositions may be prepared according to methods known in the art such that upon exposure of the capsule to a specific elevated or decreased pH, the encapsulating material rapidly dissolves, hardens, becomes permeable or the like. In one particular application, for example, the encapsulant is designed to dissolve in a solution of reduced pH. Thus, contact of the capsule of this invention with a tomato juice cocktail, or a drink containing lemon or lime juice or the like would result in rapid dissolution of the capsule, and release of the contained alcohol composition into the drink, to form an alcoholic beverage. In this manner, specific dissolution characteristics within the digestive tract may also be imparted to the capsule.

In view of the present disclosure, those skilled in the art will appreciate that a number of specific applications may benefit from inclusion of recreationally relevant quantities of ethanol in encapsulated forms of various sizes, shapes, and physico-chemical characteristics. Thus, for example, in one specific application, a capsule having the appearance of an olive, may include a sufficient quantity of ethanol such that deposition of the “olive” into a beverage will result in dissolution at a certain time after such deposition to provide a “refresher” or “kicker” to the beverage. In another specific embodiment of the capsule of this invention, a wax-based capsule containing between about 0.5 milliliters to about 50 milliliters of optionally flavored ethanol, prefereably between about 1 to about 10 milliliters The capsule according to this invention includes capsules wherein the alcoholic beverage is a wine, spirit, mixed drink, brandy, flavored alcohol, tequila, vermouth, gin, vodka, or a mixture thereof or equivalents thereof. The ethanol may be 50 proof, or any other desirable concentration may be used. The ethanol ball is chewed by a consumer, and the waxy encapsulant material is discarded, chewed like gum, or swallowed for elimination in the natural course of events. In yet a further embodiment of this invention, the alcoholic beverage may be any of a number of different wines. In this manner, aside from enjoying the physiological effects of alcohol consumption, the invention provides a novel and enjoyable means for tasting of a number of different wines. In this manner, a wine-tasting kit may also be included within the scope of this invention in the form of a container bearing a plurality of encapsulated wines of different origins and qualities. Similar kits may be envisioned for any other form of recreational alcoholic beverage. Based on the present disclosure, further uses of the alcoholic beverage containing capsules of this invention will be suggested to those skilled in the art, such as, for example, use of the alcoholic-beverage containing capsules of this invention in cooking or baking recipes for edible goods which call for inclusion of quantities of alcohol, with or without flavoring or food coloring.

Having generally described this invention, including its best mode, the following specific examples are provided to provide detailed written disclosure of the invention. However, the scope of this invention should not be construed as being limited by the specifics of these examples. Rather, the scope of this invention should be determined through reference to the complete disclosure and the claims appended hereto. It should further be noted that while the following examples provide descriptions of specific compositions of matter, produced according to disclosed small-scale processes, those skilled in the art will appreciated that highly automated and mechanized, large-scale methods for producing the encapsulated products of this invention come within the scope of this invention. Methodology known, for example, by pharmaceutical and paint-ball manufacturers is to be expected to be applicable to producing the product of this invention when modified according the principles set forth herein.

### EXAMPLE 1

This example demonstrates the manufacture of a sealed gelatin capsule containing rum which has an ethanol content of approximately 75%. Commercially-available gelatin capsules in the form of “paint-balls” were emptied of their contents by pricking opposite ends with a needle. The paint-like filling material was removed through the resulting holes. The residual filling material was rinsed out with acetone, and then with ethanol. The clean, empty shells were dried in air at room temperature and low humidity.

Some of these cleaned capsules were then chopped and mixed with an equal volume of distilled water. This mixture was heated over a hot water bath with stirring until a viscous gelatin solution was obtained. One drop of this warm solution was applied to cover the aforementioned hole in the bottom of several dried gelatin capsules. The shells were then allowed to dry. This resulted in the sealing of one hole in each capsule, leaving the upper hole open. A syringe was filled with 151 proof (75% ethanol) rum. An 18 gauge needle was affixed to the syringe, and each capsule was filled to within 2 mm of the hole with rum. A drop of warm gelatin solution was then used to cover the hole. This resulted in a sealed gelatin capsule containing 151 proof rum.

### EXAMPLE 2

This example illustrates the manufacture of imitation “olives” which contain a vermouth-flavored alcohol solution. The process described in Example 1 was used. The filling solution consisted of a mixture of ethanol, water, and vermouth with an alcohol content of approximately 60%. Green food-coloring was added in order to give the appropriate olive color. The finished capsules were stored in a solution identical to the filling material. The capsules tended to increase in size somewhat during this storage. The imitation olives gradually swelled and softened when placed into beverages such as martinis or tonic water, and were easily penetrated with a cocktail straw, allowing consumption of the contents.

### EXAMPLE 3

This example illustrates the penetration of a polymer/wax-based capsule containing wine. A commercially-available laboratory sealing film (Parafilm-M) was used to prepare the capsules in this example. This film has the ability to be stretched quite substantially in order to give a very thin membrane. A section of Parafilm-M was folded onto itself to form a rectangle which was then heat-sealed on three sides. A 20 cc sample of wine was introduced into the resulting bag via pipet. The open end was twisted shut, and the wine was “milked” towards the bottom of the capsule using finger pressure. This caused an embolism-like, spherical bulge in the lower part of the Parafilm bag. This bulge was then pinched-off from the upper part of the bag and heat-sealed using heated forceps. The resulting capsule could be put into the mouth and chewed to expel the contents, thus allowing the wine to be consumed. The waxy membrane could be swallowed, expelled, or chewed like gum if desired.

### EXAMPLE 4

This example follows the same process as Example 3; however, in this case the flexible membrane was filled with 80 proof tequila, plus a pinch of table salt, and a small slice of lemon without the rind.

### EXAMPLE 5

A glass mold was produced which consisted of a flat base plate and a conical top. A small hole was left open in the conical top. An aqueous solution of gellan gum was placed onto the base plate, and the conical top was then set in place. Additional gellan solution was then added via the hole in the conical top. The gellan solution was viscous enough that a thick film of this solution remained clinging to the sides of the glass mold. A solution consisting of 100 proof vodka and a small amount of calcium chloride was added to the mold using a syringe. This caused gelling and hardening of the gellan gum solution to form a rubbery membrane. Care was taken to avoid contact of the alcoholic calcium filling solution with the portion of the gellan solution clinging to the mold near the small orifice at the top of the glass cone. Additional gellan solution was introduced in this area so that the hole was covered. The mold was then inverted in order to finish shell formation. The capsule was removed from the shell and cured by immersion in a solution identical to the filling material.

### EXAMPLE 6

The present invention relates also to novel gelatin-based capsules that encapsulate alcoholic substances and the methods of producing the same for consumption for a variety of recreational and commercial purposes. The gelatin-based soft capsule comprises an alcohol fill formulation that is encapsulated by a gelatin-based formulation, which forms the capsule. The gelatin capsule comprises a resilient gelatin-based formulation, which forms the shell and encapsulates an alcoholic liquid fill. The present invention also comprises a method of making the softgel capsule.

Another embodiment of the present invention relates to gelatin-based capsules comprising gelatin, an alcohol sugar (preferably sorbitol), water, propylene glycol, glycerin, and Hydroxypropylmethylcellulose (HPMC). Preferably, the embodiment of the gelatin formulation that makes up the “capsule” or “shell” comprises about 35-55% gelatin, about 20-35% alcohol sugar (preferably sorbital, sorbitol, or sorbitol special), about 10-20% water, about 5-15% propylene glycol, at least 1-5% glycerin, and at least 2 g/kg of HPMC. A most preferred embodiment of the capsule comprises about 45% gelatin, about 27% sorbitol special, about 17% water, about 10% propylene glycol, about 1% glycerin, and at least 2 g/kg of HMPC. Glycerin may or may not be eliminated from the formulation depending on the amount of HPMC utilized in the mixture.

After the gelatin based composition is mixed, HPMC is added at a desired concentration to obtain optimum hardness and flexibility of the capsule. The HPMC is used to help strengthen the gelatin to withstand damaging effects to the capsules during manufacturing, transportation, and storage. The gelatin-based formulation must be capable to withstand the stress that reciprocating die machines inflict on the production of soft gelatin-based capsules such as heat and pressure. The gelatin-based capsule formulation is also capable to withstand cold temperatures when the capsules are filled with a wine that needs to be chilled when stored or just before it being used. Typically, wines are chilled at temperatures between 6-20° C.

The capsule can be made from capsule forming materials comprising gelatin. Various gelatins can be used for this purpose, preferably gelatin having a viscosity of 15 to 30 millipoises and a bloom strength up to 150 grams; gelatin having a bloom value of 160 to 250. Gelatin has the advantage as an encapsulating material in that it is heat-moldable. The gelatin capsule size and shape will vary depending on the amount of fill that will be contained therein. Preferably, the cavity within the gelatin-based capsule will enclose approximately 0.5 to 2.0 ounces of a fill formulation or include a total internal volume of the capsule between about 2.5 to about 50 milliliters (more preferably 3-10 ml). The capsule shell material can be used to form a wide variety of shapes and sizes such as spheres, oblong shapes, disks, squares, cylindrical, and shapes that resemble the appearance of a garnish associated with an alcoholic beverage. The shape and size will depend on capsule size and shell wall thickness, as well as the amount of fill formula contained therein.

The fill formulation preferably comprises at least 5-90% ethyl alcohol, about 20% water, about 9% sugar(s) (preferably D-fructose), and at least 1% of at least one excipient or flavoring component depending the use of the capsule. For example, the desired excipient or flavoring component will vary depending on whether the capsule is to be chewed or swallowed for dissolution inside the digestive, or dissolved in a beverage. A preferred embodiment of the fill formulation comprises about 70-80% ethyl alcohol (“ethanol”), about 20% water, about 9% sugar(s), and about 1% of at least one excipient or flavoring component. A most preferable embodiment of the fill formulation comprises about 70% ethyl alcohol, about 20% water, about 9% sugar(s), and about 1% of at least one excipient or flavoring component. It has been discovered that when the alcohol percent in the filling formulation is increased, the water percent should be decreased. The flavoring component can be a liqueur or any other natural or artificial flavoring used in food and beverage preparations. Other possible sweeteners can be utilized with the present invention including, but not limited to, sucrose, dextrose, alcohol sugars, d-xylose, and amino acid sweeteners.

It is submitted that a skilled artisan will be able to determine which excipients are particularly compatible without undue experimentation given the instant disclosure. The preferred excipients will also be influenced by other factors, including biocompatibility, regulatory status, ease of manufacture, cost. Such optional excipients include, but are not limited to coloring agents, taste-masking agents, buffers, hygroscopic agents, antioxidants, and chemical stabilizers.

Further, various excipients may be incorporated in, or added to, the particulate matrix to provide structure and form to the capsule shells. These excipients may include, but are not limited to, carbohydrates including monosaccharides, disaccharides and polysaccharides. For example, monosaccharides such as, dextrose (anhydrous and monohydrate), galactose, mannitol, D-mannose, sorbitol, sorbose and the like; disaccharides such as, lactose, maltose, sucrose, trehalose, and the like; trisaccharides such as, raffinose and the like; and other carbohydrates such as, starches (hydroxyethylstarch), cyclodextrins and maltodextrins. Amino acids are also suitable excipients with glycine preferred. Mixtures of carbohydrates and amino acids are further held to be within the scope of the present invention. The inclusion of both inorganic (e.g. sodium chloride, calcium chloride), organic salts (e.g. sodium citrate, sodium ascorbate, magnesium gluconate, sodium gluconate, tromethamine hydrochloride) and buffers is also contemplated. Preferably, the gelatin-based capsule comprises at least one sugar selected from the group consisting of D-fructose, dextrose, sucrose, alcohol sugars, maltose, artificial or natural sweetener, or analogs, derivatives, substitutes, and any combination thereof.

Various kinds of wines can be utilized in the present invention that include, but not limited to, light wines, sparkling wines, fortified wines, vermouths, and other fermented drinks. Other ethyl alcohols include, but are not limited to, distilled liquors such as whisky, rum, brandies (cognac, armagnac, applejack, kirsch, slivovitz, mirabelle, blackberry, peach), absinthe (made of brandy, wormwood, and other herbs), benedictine (made of brandy, sugar aromatic herbs), akavit, and vodka. Other ethyl alcohols include, but not limited to, compounded liquors such as gin, cordial or liqueurs. Some fruit cordials are apricots, blackberry, cherry, raspberry, and strawberry liqueurs. Some plant cordials include crème de menthe, crème de cacao, and creme de rose, curacao, kummel, maraschino, and chartreuse to name a few.

Capsules of the present invention can be for commercial purposes such as being filled with ethyl alcohols associated with cooking wines and sherries. For example, chefs at restaurants prepare elaborate meals that require specific amounts of a wine or sherry. Once the bottles are opened, and the spirits are not used before a certain date, the alcohol will spoiled and/or is wasted. The present invention solves this problem by encapsulating predetermined amounts of ethyl alcohols associated with cooking in rupturable or breakable gelatin-based capsules so that every time an ethyl alcohol is utilized in cooking it is robust. Since there are so many wines and liqueurs that can be utilized in cooking, where predetermined amounts of ethyl alcohols associated with cooking in gelatin-based capsule would eliminate the costs associated with keeping numerous bottles filled with different wines and liqueurs that would spoil if not used right away. Depending on the recipe, the gelatin capsule can be dissolved into the food or thrown away after the ethyl alcohol fill is extracted. Since decanting is only necessary to remove sediments from older wines, there is no need to decant the ethyl alcohol fill before use.

### EXAMPLE 7

Using the method of producing the gelatin-based capsules which is later described in detail, the capsule shells were produced from the following preferred base materials by weight:

| | |
|---|---|
| Gelatin | 45% |
| Sorbitol special | 27% |
| Water | 17% |
| Propylene Glylcol (PEG) | 10% |
| Gylcerin | 1% |
| HMPC | 2 g/kg or more |

In a preferred embodiment, the gelatin mass is first mixed together which comprises the gelatin, sorbitol, water, PEG, and glycerin. Following the mixture of the gelatin mass, at least 2 g/kg of HMPC is then mixed in to help strengthen the gelatin. Once the gelatin capsule formulation is prepared, the capsules are then formed by a reciprocating die process which produces soft capsules; however, any softgel machine that manufactures soft gelatin-based capsules can be utilized with the present invention. The alcohol-based filling were produced from the following preferred base materials by weight:

| | |
|---|---|
| Ethyl Alcohol | 70-80% |
| Water | 20% |
| D-Fructose | 9% |
| Citric acid/Natural | 1% |
| Lemon & Orange Flavors | |

Once the capsule filling formulation has been prepared, the filling can either be manufactured into the gelatin capsule when it is being processed or the filling can be later inserted into the pre-manufactured gelatin capsule shells.

The Method

Although any commercially available machine designed to manufacture soft gelatin capsules can be used with the present invention, other methods well known in the art can be utilized. For example, the reciprocating die process produces soft capsules by leading two films of capsule lamina-forming material between a set of vertical dies. The dies as they close, open, and close perform as a continuous vertical plate-forming row after row of pockets across the film. The pockets are filled with drug formulation, and as the pockets move through the dies, they are sealed, shaped, and cut from the moving film as capsules filled with agent formulation. The filled capsules next are positioned in dosage form. The continuous process is a manufacturing system that also uses rotary dies, with the added feature that the process can successfully fill drug formulation in dry powder form into capsule, in addition to encapsulating liquids. Next, the capsule is placed into dosage form, free of lamination to the internal surface of wall. Other procedures for manufacturing capsules are disclosed in U.S. Pat. No. 4,627,850, issued to inventors Deters, Theeuwes, Mullins and Eckenhoff. The present invention is not limited to rotary die encapsulation machines, while other commercially available machines that encapsulate liquids in a soft gelatin-base capsule will suffice.

After manufacture, the alcohol based formulation-filled capsules are processed to prevent the capsule shells from sticking to one another for during the manufacturing or later when the filled capsules are transported and stored. After dried in the presence of forced air, and placed into the dosage form.

Due to the manufacture of soft gelatin capsule it has been found that the outer surface of the capsule shells tend to stick to one another. To minimize or prevent the problem of capsule aggregation in the manufacture and storage, surfactants such as mineral oil and HPMC are used to coat the surfaces of the gelatin capsules. The use of these surfactants can help strengthen the capsule and reduce the number of capsules sticking together during production, transportation, and storage. It has been noticed that during the manufacture process, that if capsules are directed into pails filled with cold mineral oil and/or cold alcohol this help to prevent the capsule shells from sticking to one another. This has been noted to estimate a 70% recovery of satisfactory capsules being manufactured without sticking to one another.

Procedure

1) Take capsules from circulating cold mineral oil and place them in a pot of circulating cold alcohol (70%) and let sit.

2) Then take the capsules from the alcohol and transfer them into a fresh pail of circulating (70%) alcohol and refrigerate pail.

3) Evaluate capsule shells for stickiness.

The capsule shell can be commercially used as a chewable capsule to release a sufficient amount of high percent alcohol for sore throat to kill bacteria while being ingested along the throat. However, the most preferred use of a chewable form of the gelatin-based capsule is for human consumption for a variety of recreational purposes. The capsule is also formulated and manufactured to dissolve in aqueous solutions or in the human mouth. Preferably, the capsule is dissolved in a beverage. In addition, the capsules are formulated and manufactured to be chewed and/or ingested by an adult human.

Too much of other chemicals can cause capsule shells to be hard which causes shell fractures. Not enough of other chemicals can produce a capsule shell that is too soft and can get leakage, punctures, or sticking problems. The affinity of PEG's to shells may induce the PEG's to diffuse during storage from fillings into the gelatin enclosure. Since the PEG's act as softeners, the capsules get very soft. They stick together and deform, and when sealed into plastic films they can no longer be pressed out without damage to the capsules. As previously discussed, PEG's diffuse through the enclosure so that the surface of the shell gets smeary. Capsules in this condition must be discarded.

It will also be understood that, other components can be included in the pharmaceutical compositions of the present invention. For example, osmotic agents, stabilizers, chelators, buffers, hygroscopic agents, viscosity modulators, salts, and sugars can be added to fine tune the stabilized dispersions for maximum life and ease of administration.

Having generally described various embodiments of this invention, none of which are meant to be limiting, those skilled in the art are referred to the attached claims and equivalents thereof suggested by the present disclosure for an understanding of the scope of this invention.

What is claimed is:

1. An ingestible, chewable, or aqueous soluble non-toxic capsule containing a sufficient quantity of an ethanol composition to facilitate transport, storage, delivery and consumption of recreationally relevant quantities of such alcohol composition.

2. The capsule according to claim 1 comprising an easily transportable recreationally relevant quantity of ethanol in an ingestible container.

3. The capsule according to claim 1 comprising an easily transportable recreationally relevant quantity of ethanol in a chewable container.

4. The capsule according to claim 1 comprising an easily transportable recreationally relevant quantity of ethanol wherein said capsule is soluble, swells, softens, bursts, becomes permeable, or is easily ruptured when contacted with aqueous solutions.

5. The capsule according to claim 1 in the shape of spheres, ellipses, elongated tubes, sports mascots, logos, sporting goods, animals and humans or portions thereof, or any range of similarly shaped capsule composed of gelatin, alginate, xanthan gum, guar gum, chitin, chitosin, gellan gum, agar, carrageenan, albumin, starch, carboxymethylcellulose (CMC), or mixtures thereof.

6. The capsule according to claim 5 wherein said capsule contains within an enclosed, sealed cavity, approximately 0.5 to 1.5 ounces of an ethanol composition.

7. The capsule according to claim 6 wherein said ethanol contained within the cavity of said capsule is pure, substantially pure, or diluted ethanol, for addition to and dissolution in an aqueous solution, such as a fruit juice, soft drink or in water, or wherein the alcohol is mixed with water, syrup, gel, flavoring and the like, such that the capsule may be directly dissolved in a person's mouth or chewed.

8. The capsule according to claim 6 wherein said alcohol is between about 5% and about 95% ethanol.

9. The capsule according to claim 6 wherein said alcohol is between about 25% to about 70% ethanol.

10. The capsule according to claim 6 wherein said alcohol is between about 40% and about 50% ethanol or about 50% and 70% ethanol.

11. The capsule according to claim 1 wherein the total internal volume of the capsule is between about 2.5 milliliters to about 50 milliliters.

12. The capsule according to claim 1 wherein the total internal volume of the capsule is between about 5 milliliters and about 20 milliliters.

13. The capsule according to claim 1 wherein said capsule comprises a non-toxic material as the encapsulant to deliver the ethanol composition for recreational purposes.

14. The capsule according to claim 13 wherein the encapsulating material is digestible.

15. The capsule according to claim 14 designed for breakage, crushing, or dissolving in the consumer's mouth and optionally for subsequent expultion, or for easy swallowing.

16. The capsule according to claim 15 wherein said capsule is coated with a sugar coating, a flavored coating, a water impermeable coating, a wax coating, a coating which prevents evaporation, or a coating which combines these coatings.

17. The capsule according to claim 14 having a geometry such that the diameter of the capsule is sufficiently small to permit easy passage into the digestive tract.

18. The capsule according to claim 13 wherein the encapsulating material is non-digestible, or where the alcohol content is particularly high, having a shape that prevents swallowing, but which at the same time ensures that choking on the capsule is extremely unlikely or impossible.

19. The capsule according to claim 18 wherein the capsule is substantially too large to swallow, in which case the capsule has to be broken in the mouth, for example by chewing, or dissolved in an aqueous beverage, which is then swallowed in liquid form.

20. The capsule according to claim 18 in the form of a life-saver buoy, i.e. being of a contiguous tubular shape in the form of a circle, with an internal canal or cavity, such that upon the unlikely event of lodgment in a consumer's throat, there is sufficient space for air to pass through the canal to prevent asphyxiation.

21. The capsule according to claim 1 wherein the encapsulating material is capable of sustaining various concentrations of ethanol within the internal compartment, without dissolution into the ethanol.

22. The capsule according to claim 21 wherein said encapsulating material is sufficient to sustain packaging and storage for from several minutes to several months.

23. The capsule according to claim 22 comprising sufficient concentrations of gelatin included in the encapsulating material to form said encapsulating material, or wherein the molecules constituting the gelatin capsule are cross-linked with a cross-linking agent.

24. The capsule according to claim 23 wherein said gelatin is cross-linked with glutaraldehyde.

25. The capsule according to claim 1 comprising a pH sensitive component such that known, pH-dependent dissolution characteristics are imparted to the encapsulant.

26. The capsule according to claim 25 wherein, upon exposure of the capsule to a specific elevated or decreased pH, the encapsulating material rapidly dissolves, softens, swells, ruptures, hardens, or becomes permeable.

27. The capsule according to claim 26 wherein the encapsulant dissolves in a solution of reduced or elevated pH.

28. The capsule according to claim 1 having the appearance of a garnish.

29. The capsule according to claim 28 having the appearance of an olive.

30. The capsule according to claim 28 comprising a sufficient quantity of ethanol such that deposition into a beverage results in dissolution, swelling, rupture, ease of breakage or permeability at a certain time after such deposition to provide a “refresher” or “kicker” of released ethanol to the beverage.

31. The capsule according to claim 1 comprising a wax-based capsule containing between about 2.5 and 50 cc of optionally flavored ethanol of pure or substantially pure or diluted ethanol.

32. The capsule according to claim 31 wherein the capsule is chewed by a consumer, and the waxy encapsulant material is discarded, or chewed like gum.

33. The capsule according to claim 1 wherein the alcoholic beverage is a wine, spirit, mixed drink, brandy, flavored alcohol, tequila, vermouth, gin, vodka, or a mixture thereof.

34. A wine-tasting kit comprising a container bearing a plurality of encapsulated wines of different origins and qualities.

35. A kit comprising a series of ingestible or chewable capsules containing sufficient quantities of different alcoholic beverages such that ingestion or chewing of each said capsule releases a recreationally relevant quantity of ethanol into the digestive tract of a consumer as to permit the recreational physiological effects of ethanol consumption to be appreciated by the consumer upon consumption of one to several of said capsules.

36. A method of delivering recreationally relevant quantities of ethanol to consumers of ethanol which comprises encapsulating said recreationally relevant quantities of ethanol in non-toxic ingestible, chewable or aqueous soluble capsules.

37. A method of delivering alcohol in a recipe for a consumable good which comprises including in said recipe one or more capsules containing recreationally relevant quantities of an ethanol composition and releasing the ethanol composition into said consumable good under determined conditions.

38. A gelatin-based soft capsule encapsulating alcoholic substances for recreational and commercial purposes, comprising:
(a) a gelatin-based capsule shell comprising a formulation of gelatin, sorbitol, water, propylene glycol (PEG), and hydroxypropylmethylcellulose (HPMC); and
(b) a filling contained within said capsule shell comprising a formulation of at least 5-90% ethyl alcohol by weight of said filling, about 10% water, at least one sugar, and at least one excipient or flavoring.

39. The gelatin-based capsule according to claim 38, wherein said hydroxypropylmethylcellulose is lastly added to the mixture and before said capsule is solidified into a desired shape.

40. The gelatin-based capsule according to claim 38, wherein said gelatin forms about 40-50% by weight of said capsule shell.

41. The gelatin-based capsule according to claim 40, wherein said gelatin forms about 45% by weight of said capsule shell.

42. The gelatin-based capsule according to claim 38, wherein said sorbitol forms about 20-35% by weight of said capsule shell.

43. The gelatin-based capsule according to claim 42, wherein said sorbitol forms about 27% by weight of said capsule shell.

44. The gelatin-based capsule according to claim 38, wherein said water forms about 15-25% by weight of said capsule shell.

45. The gelatin-based capsule according to claim 44, wherein said water forms about 17% by weight of said capsule shell.

46. The gelatin-based capsule according to claim 38, wherein said PEG forms about 10% by weight of said capsule shell.

47. The gelatin-based capsule according to claim 38, wherein said HMPC forms 2 g/kg or more by weight of said capsule shell.

48. The gelatin-based capsule according to claim 38, wherein said ethyl alcohol forms about 10-80% by weight of said filling.

49. The gelatin-based capsule according to claim 48, wherein said ethyl alcohol forms about 70-80% by weight of said filling.

50. The gelatin-based capsule according to claim 49, wherein said ethyl alcohol forms about 70% by weight of said filling.

51. The gelatin-based capsule according to claim 38, wherein said water forms about 20% by weight of said filling.

52. The gelatin-based capsule according to claim 38, wherein at least one said sugar combines and forms about 9% by weight of said filling.

53. The gelatin-based capsule according to claim 52, wherein said at least one sugar is selected from the group consisting of D-fructose, dextrose, sucrose, alcohol sugars, maltose, artificial or natural sweetener, or analogs, derivatives, substitutes, and any combination thereof.

54. The gelatin-based capsule according to claim 38, wherein at least one said excipient or flavoring forms about 1% by weight of said filling.

55. The gelatin-based capsule according to claim 38, wherein said capsule shell formulation further comprises glycerin.

56. A method of manufacturing a soft gelatin-based capsule(s) encapsulating an alcoholic substance for a variety of recreational or commercial purposes in claim 38.

57. The method of claim 56, wherein said method comprising the step of directing formed said gelatin-based capsule(s) into a cold mineral oil bath or a cold alcohol bath, or a combination of both.

58. A gelatin-based soft capsule encapsulating alcoholic substances for recreational and commercial purposes, comprising:
(a) a gelatin-based capsule shell comprising a formulation of about 40-50% gelatin, sorbitol, water, propylene glycol (PEG), glycerin, and at least 2 g/kg of hydroxypropylmethylcellulose (HPMC); and
(b) a filling contained within said capsule shell comprising a formulation of at least 5-90% ethyl alcohol by weight of said filling, water, at least one sugar, and at least one excipient or flavoring.

59. A method of manufacturing a soft gelatin-based capsule(s) encapsulating an alcoholic substance for a variety of recreational or commercial purposes in claim 58.

60. The method according to claim 59, wherein said method comprises the step of directing formed said gelatin-based capsule(s) into a cold mineral oil bath or a cold alcohol bath, or a combination of both.

61. The method according to claim 59, wherein said soft gelatin capsules are provided in a kit form comprising a plurality of said ethanol filled capsules for commercial or recreational use.
